(19) United States
(12) Patent Application Publication
(10) Pub. No.: US 2010/0141210 A1
(43) Pub. Date: Jun. 10, 2010

(54) ALTERNATOR FOR CHARGING MULTIPLE ELECTRIC STORAGE DEVICES

(75) Inventor: Jacob E. Shaffer, JR., Phoenix, AZ (US)

Correspondence Address: CANTOR COLBURN, LLP, 20 Church Street, 22nd Floor, Hartford, CT, 06103, US

(73) Assignee: REMY TECHNOLOGIES, L.L.C., Pendleton, IN (US)

(21) Appl. No.: 12/632,282

(22) Filed: Dec. 7, 2009

(51) Int. Cl. H02J 7/00

(52) U.S. Cl. 320/126

(57) ABSTRACT

An alternator includes a body portion housing a charging circuit. A voltage regulator is mounted to the body portion and electrically coupled to the charging circuit. The voltage regulator is configured and disposed to output at least one charging current. An isolator is mounted to the body portion and electrically coupled to the charging circuit and the voltage regulator. The isolator is configured and disposed to be electrically coupled to at least two batteries with the isolator independently passing the at least one charging current to each of the first and second batteries.

### BACKGROUND OF THE INVENTION

Exemplary embodiments pertain to the art of electrical machines and, more particularly, to an alternator for selectively independently charging multiple electric storage devices.

Many trucks, recreational vehicles, and boats utilize multiple batteries or banks/sets of batteries to operate various electrical loads. For example, one battery, or set of batteries, is used for starting lighting and ignition (SLI) while another battery, or set of batteries, is used to power hotel loads such as air conditioners, and the like. In some cases, separate alternators, or single alternators having a DC-to-DC converter, having an associated voltage regulator, are utilized to charge each battery or set of batteries. Separate alternators are particularly employed when the SLI battery(s) and the hotel battery(s) require different charge profiles. In other cases, a single alternator is utilized to charge both batteries, or sets of batteries. When employing a single alternator, in addition to a voltage regulator, an isolator must be employed. The isolator selectively connects the battery or sets of batteries to the alternator for charging purposes. In this manner, the isolator ensures that an under-charged battery will not draw down a battery of a higher charge.

A typical isolator includes a plurality of large diodes that charge the battery having the lowest state of charge (SOC) first, until both batteries reach a similar SOC at which point current will flow to both batteries. The large diodes utilized in conventional isolators typically have a voltage drop of 0.7 volts or more. This large voltage drop has a negative impact on charging. In order to overcome the negative impact of the 0.7 volt voltage drop, many charging systems employ an independent voltage sensing line that measures battery voltage at the batteries or on a battery side of the isolator. Conventional voltage regulators used in vehicle charging systems have a limited charging ability. That is, the voltage regulators currently being used in vehicle charging systems can only control charging to one battery type. Thus, existing systems are limited to charging batteries of the same type and the same voltage rating.

### BRIEF DESCRIPTION OF THE INVENTION

Disclosed is an alternator including a body portion housing a charging circuit. A voltage regulator is mounted to the body portion and electrically coupled to the charging circuit. The voltage regulator is configured and disposed to output at least one charging current. An isolator is mounted to the body portion and electrically coupled to the charging circuit and the voltage regulator. The isolator is configured and disposed to be electrically coupled to at least two batteries with the isolator independently passing the at least one charging current to each of the first and second batteries.

Also disclosed is a method of charging at least two batteries. The method includes passing a first charging current having a first charging profile from a voltage regulator to an isolator, both the voltage regulator and the isolator are mounted in an alternator. The method also includes passing a second charging current having a second charging profile from the voltage regulator to the isolator, sending the first charging current from the isolator to a first battery, and the second charging current to a second battery, and charging the first battery independent of the second battery.

Still further disclosed is an alternator system including a body portion housing a charging circuit, a voltage regulator mounted to the body portion and electrically coupled to the charging circuit. The voltage regulator is configured and disposed to output at least one charging current. An isolator is mounted to the body portion and electrically coupled to the charging circuit and the voltage regulator. A first battery is electrically coupled to the isolator, and a second battery is electrically coupled to the isolator independent of the first battery. The isolator passes the at least one charging current to each of the first and second batteries.

### BRIEF DESCRIPTION OF THE DRAWINGS

The following descriptions should not be considered limiting in any way. With reference to the accompanying drawings, like elements are numbered alike:

FIG. 1 is an alternator for charging multiple electric storage devices constructed in accordance with an exemplary embodiment;

FIG. 2 is a schematic diagram illustrating an alternator including an integrated voltage regulator and isolator in accordance with an exemplary embodiment; and

FIG. 3 is a schematic diagram of a charging circuit for the alternator of

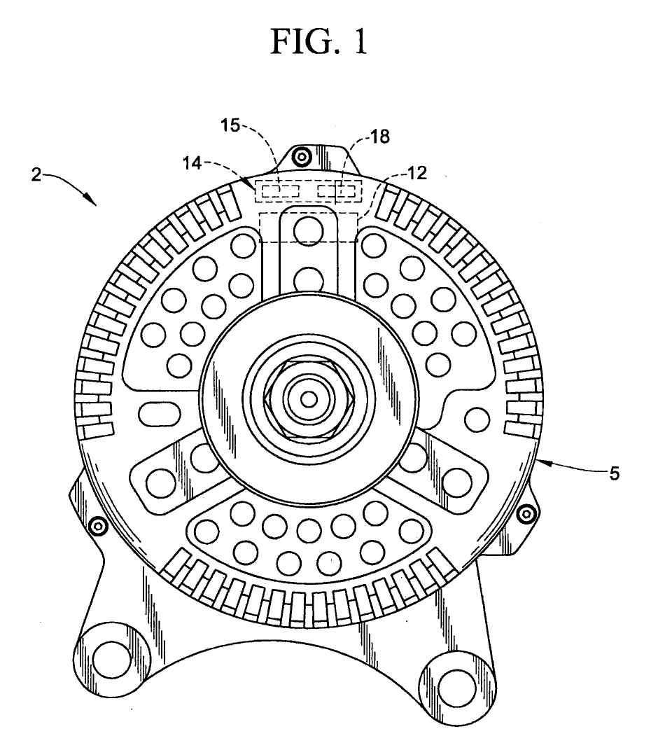

FIG. 1.

### DETAILED DESCRIPTION OF THE INVENTION

A detailed description of one or more embodiments of the disclosed apparatus is presented herein by way of exemplification. With reference to FIG. 1, an alternator constructed in accordance with an exemplary embodiment as indicated generally at 2. Alternator 2 includes a body portion 5 that houses a stator (not shown) and a rotor (also not shown) that produce an electrical current for a charging circuit 12. Charging circuit 12 is electrically connected to a regulator control circuit 14 having a voltage regulator portion 15 and an isolator 18. In the exemplary embodiment shown, both voltage regulator 15 and isolator 18 are arranged upon body portion 5.

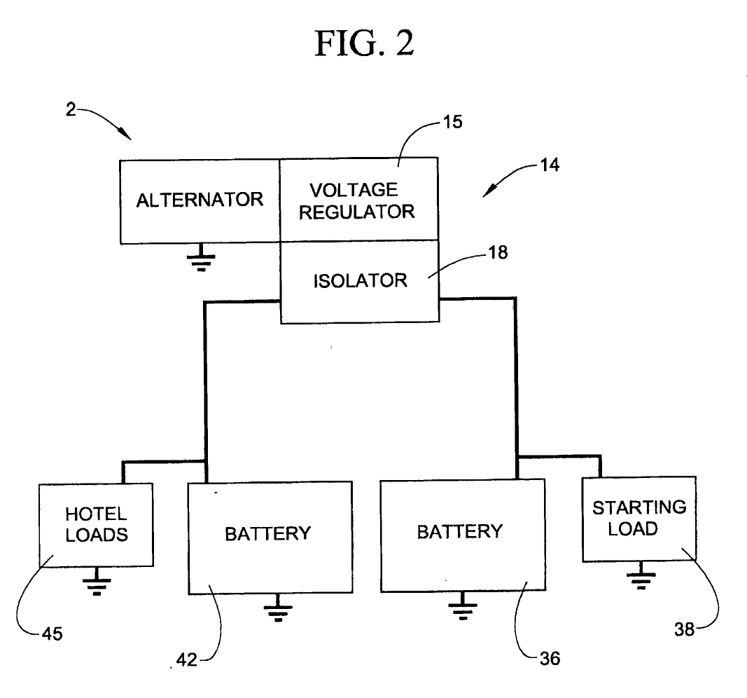

In accordance with an exemplary embodiment, alternator 2 is configured to charge multiple electrical storage devices as shown in FIG. 2. That is, a first battery or bank of batteries 36 is coupled to isolator 18. Battery 36 provides electrical power for starting, lighting and ignition (SLI) loads indicated at 38. A second battery or bank of batteries 42 is also coupled to isolator 18. Battery 42 provides power for various hotel loads 45. In a manner known in the art, hotel loads 45 could include air conditioning loads, microwave ovens, entertainment systems and the like or other loads not associated with starting lighting and ignition typically found in a tractor trailer and/or recreational vehicle. In order to properly charge each battery 36 and 42, alternator 2 is configured to deliver a charging current through voltage regulator 15. The particular form of the charging current will depend upon the type of battery connected to isolator 18. That is, alternator 2 is configured to charge batteries that require different charging profiles or which may have different voltage capacities. For example, battery 46 could be an absorbent glass mat (AGM) battery and require a first charging profile, while battery 36 could be a flooded battery that requires a second charging profile. AGM batteries and flooded batteries require different charging profiles in a manner known in the art.

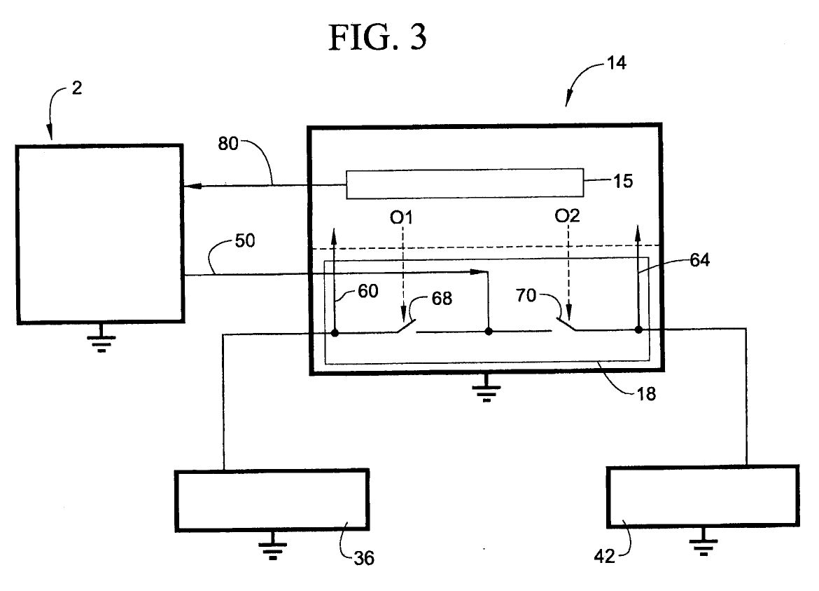

As best shown in FIG. 3, voltage regulator 15 of regulator control circuit 14 receives a charging current 50 from alternator 2, while isolator 18 delivers the charging current 50 to batteries 36 and 42 as will be described below. Towards that end, isolator 18 includes a first voltage sensing line 60 that is electrically coupled to battery 36. Voltage sensing line 60 detects a state of charge (SOC) for battery 36. Regulator control circuit 14 also includes a second voltage sensing line 64 that is electrically coupled to battery 42. In a manner similar to that described above, voltage sensing line 64 determines the current SOC for battery 42. Isolator 18 also includes a first switch 68 that is configured to selectively electrically connect charging current 50 and battery 36 and a second switch 70 that is configured to selectively electrically connect charging current 50 and battery 42.

Depending upon the SOC, regulator control circuit 14 will initiate charging for one, the other, or both batteries 36 and 42. For example, in the event that battery 36 has the lowest state of charge, regulator control circuit 14 will close switch 68 sending charging current 50 to battery 36. Once battery 36 reaches the desired SOC, regulator control circuit 14 will open switch 68 and close switch 70 sending a charging current 50 to battery 42. In addition to providing independent charging for battery 36 and battery 42, regulator control circuit 14 establishes the particular charging profile required. More specifically, if battery 36 is to be charged, voltage regulator 15 signals alternator 2 through a control line 80 to provide the necessary charging input. Alternator 2 current is designed to provide the required charging profile for each battery 36, 42.

At this point, it should be understood that the present invention provides a system for charging multiple electric storage devices through a single alternator. In addition to charging multiple electric storage devices, the alternator in accordance with the exemplary embodiment enables selective charging of different types of electric storage devices having different charging profiles. That is, instead of requiring multiple alternators to charge different types of batteries, the alternator in accordance with the exemplary embodiment is configured to set a desired charging profile based on the type of electrical storage device requiring charging.

While the invention has been described with reference to an exemplary embodiment or embodiments, it will be understood by those skilled in the art that various changes may be made and equivalents may be substituted for elements thereof limitation with reference to the Figures without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. An alternator comprising:
a body portion including a charging circuit;
a voltage regulator mounted to the body portion and electrically coupled to the charging circuit, the voltage regulator being configured and disposed to output at least one charging current; and
an isolator mounted to the body portion and electrically coupled to the charging circuit and the voltage regulator, the isolator being configured and disposed to be electrically coupled to at least two batteries, the isolator independently passing the at least one charging current to each of the first and second batteries.

2. The alternator according to claim 1, wherein the voltage regulator is configured and disposed to output a first charging current having a first charging profile and a second charging current having a second charging profile.

3. The alternator according to claim 2, wherein the first charging current is distinct from the second charging current.

4. The alternator according to claim 2, wherein the first charging profile is configured for charging absorbent gas mat (AGM) batteries and the second charging profile is configured for charging flooded batteries.

5. A method of charging at least two banks of batteries, the method comprising:
passing a first charging current having a first charging profile from a voltage regulator to an isolator, both the voltage regulator and the isolator being mounted in an alternator;
passing a second charging current having a second charging profile from the voltage regulator to the isolator;
sending the first charging current from the isolator to a first battery, and the second charging current to a second battery; and
charging the first battery independent of the second battery.

6. The method of claim 5, wherein charging the first battery independent of the second battery comprises charging the first and second batteries simultaneously.

7. The method of claim 5, wherein charging the first battery independent of the second battery comprises charging the first battery for a first time period and the second battery for a second time period.

8. The method of claim 7, further comprising: alternating the first and second time periods.

9. The method of claim 5, wherein charging the first battery comprises charging an absorbent gas mat (AGM) battery and charging the second battery comprises charging a flooded battery.

10. The method of claim 5, further comprising:
sensing voltage from the first battery;
sensing voltage from the second battery; and
charging one of the first and second batteries based on sensed voltage.

11. An alternator system comprising:
a body portion including a charging circuit;
a voltage regulator mounted to the body portion and electrically coupled to the charging circuit, the voltage regulator being configured and disposed to output at least one charging current;
an isolator mounted to the body portion and electrically coupled to the charging circuit and the voltage regulator;
a first battery electrically coupled to the isolator; and
a second battery electrically coupled to the isolator independent of the first battery, wherein the isolator passes the at least one charging current to each of the first and second batteries.

12. The alternator system according to claim 11, wherein the voltage regulator is configured and disposed to output a first charging current having a first charging profile to the first battery and a second charging current having a second charging profile to the second battery.

13. The alternator system according to claim 12, wherein the first charging current is distinct from the second charging current.

14. The alternator system according to claim 12, wherein the first battery is an absorbent gas mat (AGM) battery and the second battery is a flooded battery.
